(19) United States
(12) Patent Application Publication
(10) Pub. No.: US 2020/0018381 A1
(43) Pub. Date: Jan. 16, 2020

(54) ROTARY FEED-THROUGH HAVING A GEARING

(71) Applicant: FORSCHUNGSZENTRUM JUELICH GMBH, JUELICH (DE)

(72) Inventors: Daniel HOESCHEN, Aachen (DE); Guntram CZYMEK, Aachen (DE)

(21) Appl. No.: 16/490,610

(22) PCT Filed: Mar. 10, 2018
(86) PCT No.: PCT/DE2018/000063

§ 371 Date: Sep. 3, 2019

(30) Foreign Application Priority Data
Apr. 5, 2017 (DE) 10 2017 003 305.6

(51) Int. Cl. F16H 1/32; F16J 15/52; F16H 57/029

(52) U.S. Cl. CPC F16H 1/321; F16J 15/525; F16H 2001/327; F16H 2001/323; F16H 57/029

(57) ABSTRACT

A rotary feedthrough includes a first shaft connected to a first gear via a coupling and a second shaft configured to be mounted in a housing and fixedly connected to a second gear. One of the first gear and the second gear is an external gear with i teeth and the other of the first gear and the second gear is an internal gear with i+x teeth, where i=3, 4 . . . n and x=1, 2 . . . n. The external gear is arranged inside the internal gear. The rotary feedthrough further includes a coupling configured to couple a gear to the first shaft in such a way that a rotational movement of the shaft leads to an eccentric movement of the gear coupled thereto. In addition, the rotary feedthrough includes a seal configured to connect the gear coupled to the first shaft to the housing.

### CROSS REFERENCE TO RELATED APPLICATIONS

This application is a U.S. National Phase Application under 35 U.S.C. § 371 of International Application No. PCT/DE2018/000063, filed on Mar. 10, 2018, and claims benefit to German Patent Application No. DE 10 2017 003 305.6, filed on Apr. 5, 2017. The International Application was published in German on Oct. 11, 2018, as WO 2018/184611 under PCT Article 21(2).

### FIELD

The invention relates to a rotary feedthrough for the transmission of rotational movements, in particular a geared rotary feedthrough, which can advantageously be hermetically sealed.

### BACKGROUND

Numerous mechanical feedthroughs, with the aid of which a rotational movement can be transmitted, are described in the literature. In the transmission of mechanical rotational movements into a vacuum system, for example, elastomer-sealed feedthroughs or bellows seals are known. Furthermore, magnetically coupled feedthroughs exist in which a movement is transmitted by means of an atmosphere-side device via a magnetic coupling to a shaft in a vacuum, or even via feedthroughs sealed by magnetofluids. However, such magnetic feedthroughs are not suitable in some applications in medical technology or in fusion experiments in which magnetic effects play a part.

For the transmission of a rotational motion using a bellows with a hermetic separation between vacuum and atmosphere, the so-called cattail or wobble principle is also known, which is schematically shown in FIG. 1 from [1]. Here, an angled drive shaft (1), whose end is supported in a crank pin (3), rotates the output shaft (4) in the vacuum. The hermetic sealing is effected by the non-rotating bellows seal (2) which, like the drive shaft, performs a wobbling movement. The output and drive shafts are supported by means of stainless steel ball bearings which are coated with a vacuum-compatible dry lubricant. For example, hybrid bearings with ceramic balls can also be used for ultra-high vacuum (UHV) applications.

In the case of the aforementioned rotary feedthrough, a hermetic shielding can advantageously be realized. Disadvantageously, however, no speed change of the rotational movements is provided for it. In addition, as a rule, only small torques of at most, for example, 5 or 10 Nm can be transmitted.

Mechanical speed reducers are also known from the literature, with the aid of which a first rotational motion D1 can be transferred via a transmission into a second rotational motion D2 ≠ D1. As an example, the so-called cycloidal speed reducer may be mentioned.

A cycloidal speed reducer is a special form of an eccentric speed reducer. The operation of a cycloidal speed reducer can be illustrated with the aid of FIG. 2 from [2].

With a rotational motion D1, an eccentric drives an inner cam disk, the number of whose cam sections being i, doing so, for example, via a ball bearing. The cam disk rolls within a fixed outer pin ring with i+1 pins and thus executes a wobbling rotational motion D2 ≠ D1. With each revolution of the drive wheel, the output moves further around a cam section. The rotational motion of the inner cam disk can be captured via pins and transmitted to the output shaft. The output shaft of a cycloidal speed reducer generally has significantly lower rotational speeds in comparison with the drive rotation.

With respect to vacuum applications, cycloidal speed reducers further have the advantage that the cam disks transmit the torque in a rolling manner.

Accordingly, with a suitable choice of material, it is also possible to dispense with lubricants, which brings with it significant advantages particularly in the case of an application in a vacuum. Cycloidal speed reducers are generally very long-lived and only require little maintenance.

Both eccentric speed reducers and cycloidal speed reducers can be constructed in a variety of configurations and gear stages. High transmission ratios can regularly be achieved here. Typical ratios for single-stage cycloidal speed reducers range, for example, from 29:1 to 179:1. These speed reducers can here be subjected to high torques (compact speed reducers of up to several thousand Nm are commercially available) and, in addition, can be overloaded with shocks by a factor of 5. In addition to their high loadability, high positioning accuracies can also be achieved, typically <1 arcmin. The aforementioned speed reducers are therefore also often used in robotics.

However, due to the lack of sealing possibilities, a cycloidal speed reducer is not generally suitable for use as a rotary feedthrough at the boundary between two spaces at different pressures (P1, P2), and in particular at the boundary between vacuum and atmosphere.

### SUMMARY

In an embodiment, the present invention provides a rotary feedthrough. The rotary feedthrough includes a first shaft connected to a first gear via a coupling and a second shaft configured to be mounted in a housing and fixedly connected to a second gear. One of the first gear and the second gear is an external gear with i teeth and the other of the first gear and the second gear is an internal gear with i+x teeth, where i=3, 4 . . . n and x=1, 2 . . . n. The external gear is arranged inside the internal gear and is able to roll therein. The rotary feedthrough further includes a coupling configured to couple a gear to the first shaft in such a way that a rotational movement of the shaft leads to an eccentric movement of the gear coupled thereto. In addition, the rotary feedthrough includes a seal configured to connect the gear coupled to the first shaft to the housing.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic representation of the so-called cattail principle;

FIG. 2 is a schematic representation of a prior art cycloidal speed reducer;

FIG. 3 is a schematic sectional drawing of a rotary feedthrough according to an embodiment of the invention with an internal gear fixedly connected to the output shaft;

FIG. 4 is a schematic sectional drawing of a rotary feedthrough according to an embodiment of the invention with an external gear fixedly connected to the output shaft;

FIG. 5 is a schematic sectional drawing of a rotary feedthrough according to an embodiment of the invention with a wobbling/fixed external gear;

FIGS. 6a, 6b, and 6c are schematic illustrations of coupling mechanisms between a drive shaft and an internal or external gear;

FIG. 7 is a schematic illustration of the meshing of an external gear with i+x teeth in an internal gear with i teeth;

FIGS. 8a and 8b provide schematic sectional drawings of a rotary feedthrough according to embodiments of the invention with the additional support of an Oldham coupling;

FIG. 9 is a schematic representation of an Oldham coupling;

FIG. 10 is a schematic representation of a rotary feedthrough according to an embodiment of the invention, here with 10 pins/rolling elements as internal gear and a cam disk with 9 teeth as external gear.

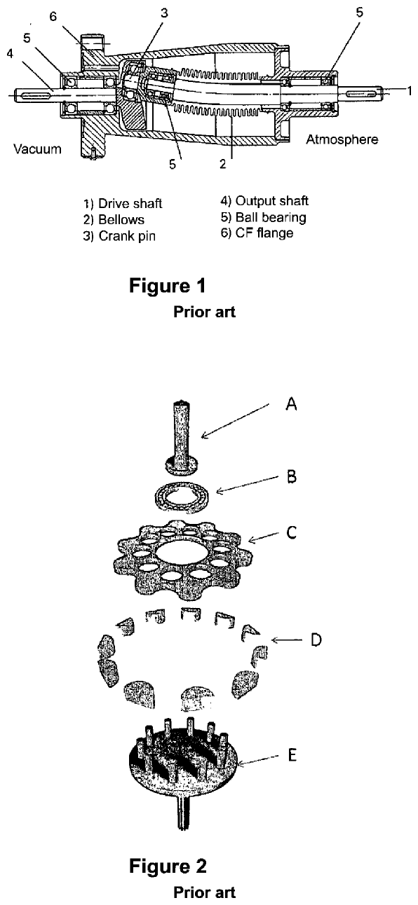

### DETAILED DESCRIPTION

Embodiments of the invention enable a rotary feedthrough to transmit a mechanical rotational motion from a first space into a second space, wherein the spaces can be separated hermetically from one another, such as, for example, in vacuum applications.

In particular, embodiments of the invention provide a rotary feedthrough for two spaces at different pressures P1 and P2, wherein advantageously P1 or P2 may be a vacuum.

Further, embodiments of the invention provide a device of this kind which not only makes possible a high positioning accuracy by way of a high reduction ratio but that is also suitable for high torques >20 Nm.

According to embodiments of the invention, it has been found that the principles of an eccentric or a cycloidal speed reducer can advantageously be used for a rotary feedthrough that is also to be used in vacuum, wherein additionally a sealing of the eccentric movement by means of bellows is used, in a similar way as is provided with the cattail principle.

Rotary feedthroughs according to embodiments of the invention therefore comprise an optimized combination of an eccentric or cycloidal speed reducer with a bellows seal. If the rotary feedthrough is to be operated at least on one side in a vacuum, care should be taken that materials are compatible with a vacuum

An eccentric movement is to be understood as a movement of a body in which all points of the body rotate at the same angular velocity on the same circles around different parallel axes. Unlike rotation, the body does not change its orientation in space. It is therefore a pure translation.

An eccentric in mechanics and in mechanical engineering is understood to mean a control disk mounted on a shaft, the center point of which lies on the shaft axis.

With an eccentric, rotational (rotary) movements, for example, can be converted into translational (longitudinal) movements and vice versa. The less the eccentricity, the more force can be developed by the drive shaft and the shorter the stroke becomes. The purpose of the eccentric can therefore be on the one hand to effect the conversion from rotational to translational movement or on the other hand to provide a force amplification, wherein both effects are generally desired.

Although rotary feedthroughs according to embodiments of the invention are constructed similarly to a standard cycloidal speed reducer, they nevertheless have some decisive differences.

Rotary feedthroughs according to embodiments of the invention comprise a first shaft with a means for coupling this shaft to a first gear and a second shaft supported in a housing and connected to a second gear. The first and second gears are on the one hand an internal gear with i+x inner teeth and [on the other hand] an external gear 6 with i outer teeth. Here i=3, 4, 5 to n; x=1, 2, 3 to n; and n=a natural, positive number. The dimensions of the external gear in relation to the internal gear are such that the external gear is able to roll inside the internal gear. Furthermore, the rotary feedthrough comprises at least one means for sealing, which is arranged between a housing and one of the gears-depending on the development of the invention—and which preferably comprises a seal, for example a bellows.

When an “external gear” is referred to in this application, a cam disk or a cycloid disk as used in a conventional cycloidal speed reducer is also and in particular meant, and in the case of the term “internal gear” as used here pins or rollers or rolling bodies or a pin ring are also and in particular to be included.

In the context of the invention, a housing can be understood to mean a part of a delimitable space into or out of which a rotational movement is to take place on the part of the rotary feedthrough according to the invention.

The first shaft is preferably operated as a drive shaft and correspondingly the second shaft as an output shaft. This, however, is not obligatory.

The second shaft fixedly supported in the housing is fixedly connected to a gear. In this context, “fixedly” does not necessarily mean a material-to-material connection, but only that there is a 1:1 transmission of the rotational movement of the shaft and of the gear connected thereto.

In contrast, the first shaft is connected to the other gear via a means for coupling which permits a transmission of the rotational movement of the shaft into an eccentric movement of the gear connected thereto.

The external gear and the internal gear are geometrically adapted to each other. The external gear is disposed within the internal gear such that the external gear can roll on the internal gear if the internal gear is fixedly connected to a shaft, or the internal gear can roll around the external gear if the external gear is fixedly connected to a shaft.

Depending on the design, the second shaft can be fixedly connected to an external gear or an internal gear. The first shaft is then in each case correspondingly connected to the other gear via a coupling mechanism.

As a simple embodiment of the mechanism for coupling, for example, an eccentric is to be mentioned which is fixedly connected to the first shaft and, in particular, couples the gear to the shaft via a bearing.

In one design, the eccentric has a recess which is not arranged centrally with respect to the drive shaft and with which a pin arranged centrally on an internal gear or external gear engages. In the case of the recess, which is not arranged centrally, the rotational movement of the drive shaft thus leads to an eccentric movement which is transmitted via a pin to the internal or external gear. The pin and recess are geometrically matched to each other.

In an alternative design, the eccentric has a pin which is not arranged centrally with respect to the first shaft and which engages with a recess arranged centrally on the internal or external gear. In this case, the rotational movement of the first shaft also leads to an eccentric movement via the non-centrally arranged pin, which is transmitted via a pin to the recess in the internal or external gear. In this case as well, the pin and recess are geometrically matched to each other.

Another alternative embodiment of the coupling mechanism provides that the first shaft is angled at the end and its end terminates in a pin which engages with a recess arranged centrally on the gear to be coupled.

In various embodiments, the pin and recess can advantageously be flexibly connected via a bearing, for example a ball bearing, so as to run particularly smoothly.

Accordingly, in the rotary feedthroughs according to embodiments of the invention, one gear is fixedly connected to the second shaft and the other corresponding gear is flexibly connected to the other, first shaft via a means for coupling, the flexible connection allowing a transmission of the rotational movement of the drive shaft into an eccentric movement of the gear coupled thereto.

By using an outer internal gear with i+x inner teeth, where i=3, 4, 5 to n and x=1, 2 to n, as well as an inner external gear with i outer teeth, transmission of the rotational movement is not 1:1 but there is always a gear reduction in the rotational movement from the drive shaft to the drive shaft. Here the reduction in the rotational movement is greater, the higher the value selected for x and the lower for i, wherein x cannot be selected to be absolutely of any magnitude but will always for geometric reasons stand in a specific relation to i.

By virtue of the fact that the gear coupled to the first shaft cannot perform a rotational movement but instead a two-dimensional eccentric movement perpendicular to the axis of the first shaft, it is advantageously possible to realize a seal between the housing and the gear coupled to the first shaft.

This seal can in particular be hermetic, so that two delimitable spaces are respectively created on the drive side and the output side of this rotary feedthrough, which may differ in the pressures there prevailing and/or in the media (gas/liquid) contained there without transmission of the rotational movement being influenced thereby.

The seal is advantageously of a flexible design since it has to accommodate the eccentric movement of the gear coupled to the shaft 1 relative to the housing. The seal comprises, for example, one or a plurality of bellows or also just one flexible film. The material used in the sealing can advantageously be adapted to the corresponding requirement regarding temperature, the pressure difference set, or even the media present (aggressive, corrosive, etc.).

A mode of operation of a rotary feedthrough according to a first embodiment of the invention is described in a non-restrictive manner below.

The first shaft (in this case the drive shaft) with an eccentric as a coupling mechanism transmits the rotational movement D1 of the shaft into an eccentric movement of the internal gear coupled thereto. The eccentric movement of the internal gear 5 leads, in a manner analogous to how a cycloidal speed reducer works, to the external gear fixedly connected to the second shaft (here the output shaft) rolling on the teeth of the internal gear and thereby experiencing a rotational movement D2 itself. By arranging i+x teeth on the internal gear and i teeth on the external gear, a transmission of the rotational movements is effected in such a way that a rotational movement D2<D1, i.e. a reduction, results on the output side.

Due to the fact that the internal gear performs an eccentric movement but not a rotational movement, it can advantageously be connected via a hermetic seal to a housing in which the output shaft 3 is mounted. In one embodiment of the invention, the seal comprises a bellows. This embodiment is thus particularly suitable for using the rotary feedthrough at a boundary of two spaces with different pressures. For example, a pressure P1 may be set in the housing, while outside the housing, on the drive shaft side, a pressure P2>P1 prevails.

A difference between rotary feedthroughs according to embodiments of the invention and a cycloidal speed reducer is that, as a result of the rotational movement of the drive shaft in a cycloidal speed reducer, an inner circular disk with outer teeth (external gear) is simultaneously put into an eccentric movement and into a rotational movement, while in rotary feedthroughs according to embodiments of the invention the internal gear is only put into an eccentric movement.

In contrast to a cycloidal speed reducer, the drive shaft can thereby advantageously be hermetically sealed in relation to the output shaft so that such a rotary feedthrough is particularly suitable for transmitting a rotational movement into or out of a vacuum. The sealing can be effected, for example, via one or a plurality of bellows.

The crucial point in the invention lies in the transition of a rotational movement D1 of a first shaft (in particular of a drive shaft) into a purely translational movement (eccentric movement) and from this again to a rotational movement D2 of the output shaft, combined with the possibility of hermetic sealing, which thus makes it possible to use this device in particular at the boundary between atmospheric pressure and vacuum.

If the seal is not of itself designed to be torsionally rigid, an additional Oldham coupling can optionally also ensure that the gear coupled to the drive shaft performs only an eccentric movement and not a rotational movement, and in this way the seal also does not undergo any rotational movement nor needs to absorb it.

A mode of operation of a rotary feedthrough according to a second embodiment of the invention is described in a non-restrictive manner below:

A first shaft (drive shaft) transmits the rotational movement D1 of the drive shaft via a means for coupling into an eccentric movement of the external gear coupled to the drive shaft. In a similar way to how a cycloidal speed reducer works, the eccentric movement of the external gear results in the internal gear fixedly connected to the second shaft (output shaft) rolling on the teeth of the external gear and thereby undergoing a rotational movement D2 itself. By arranging i teeth on the external gear and i+x teeth on the internal gear, a transmission of the rotational movement takes place also in this embodiment in such a way that a rotational movement D2<D1, i.e. a reduction, results.

Due to the fact that in this embodiment the external gear performs an eccentric movement but no rotational movement, the hermetic sealing lies in this case between the housing and the external gear, wherein optionally the external gear has an additional device which extends beyond the dimensions of the internal gear correlating with the external gear so as to make possible a good connection of the seal to the housing. This additional device can here be regarded as part of the external gear or also as part of the seal.

Such an additional device could be, for example, a circular disk which is fixed on the outside of the external gear which rolls within the internal gear and has a significantly larger diameter than the internal gear. A bellows, for example, which is connected to the housing, could then be attached to the outer edge, so that even in the case of an eccentric movement of the external gear the bellows does not abut against the internal gear. This embodiment too is thus also particularly suitable for using the rotary feedthrough at a boundary of two spaces with different pressures or media which have to be sealed from each other.

In the simplest case, the seal can itself consist of a bellows seal with only one bellows. However, embodiments having a plurality of bellows seals are also possible. Depending on the geometry of the housing at the location of the rotary feedthrough, any other flexible possibility of sealing is also conceivable as long as it permits an eccentric movement relative to a fixed housing, such as, for example, a flexible film.

The sealing should be suitable for the possible fields of application and the temperatures and pressure conditions set there. When used in aggressive media, a corresponding stability and durability of the materials used, in particular of the bellows or the film, must be ensured.

It is particularly advantageous that rotary feedthroughs according to embodiments of the invention can manage without lubricant, and as a result, the range of application of such rotary feedthroughs is not limited to specific temperature ranges, as is otherwise known from the prior art for transmissions with lubricants which are only allowed to be used or operated within a specific temperature interval.

In the case of a rolling movement, such as occurs between the external gear and the internal gear, there are not generally any surfaces sliding over each other. This advantageously reduces the risk of seizing, which could adversely affect the functionality of the rotary feedthrough. Furthermore, the risk of small particles breaking out of the surface can be reduced in this way. This is particularly important in the case of utilization in a UHV if no contaminants are to be produced.

Furthermore, it is again noted that although rotary devices according to embodiments of the invention can be used particularly advantageously when different pressures prevail on the drive shaft and output shaft sides, this is not mandatory. It is also conceivable that at identical pressures on the drive shaft sides (P1=P2), be this underpressure, atmospheric pressure or overpressure, a seal is required because, for example, one side must not be exposed to any aggressive or corrosive medium but the other side reacts insensitively to this medium.

The transmission of the forces typical of cycloidal speed reducers via pins or rollers, called gears in the context of this invention, advantageously makes possible a high efficiency, a long service life and extremely low backlash of the speed reducer. This low level of backlash advantageously makes possible a very good positioning. The high positioning accuracy is here achieved by a high reduction and a simultaneous zero backlash of the speed reducer, assuming a corresponding rigid torque support.

The rolling friction of all elements involved in the force transmission guarantees a very low breakaway torque.

All common materials as already known from the prior art for cycloidal speed reducers are suitable as material for the gears disclosed in this application or for the surface coating of the gears. Particular mention may be made here of metals, high-performance plastics and ceramics, wherein the gears can be manufactured completely from these materials or can also be coated only with these materials.

Ceramics are particularly advantageous for use in a vacuum or high vacuum, since they manage without lubricant, have a high load rating, i.e. are highly loadable, and are particularly suitable for high temperatures and high rotational speeds. In this case, it would even suffice were only one of the gears, i.e. the internal gear or the external gear, manufactured from a ceramic, comprised a ceramic, or were only coated with a ceramic.

Optionally, a clutch can additionally be provided, which can compensate for an axial displacement between the drive shaft and the output shaft. An Oldham coupling is, for example, a coupling especially well-suited for this purpose.

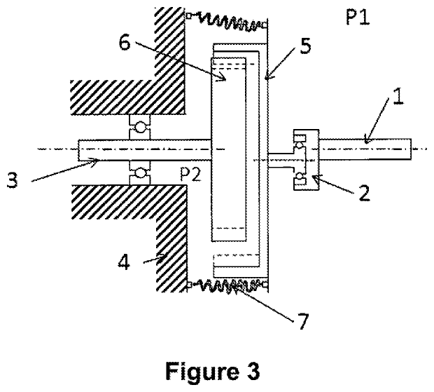

The function of a rotary feedthrough according to an embodiment of the invention, as shown schematically in FIG. 3, is explained in the following by way of example on the basis of a simple eccentric speed reducer with hermetic sealing.

Via the drive shaft 1, the internal gear (outer ring with inner teeth) 5 of the rotary feedthrough is forced into an eccentric orbit by means of an eccentric body 2. In the present case, this takes place by means of a non-centrally arranged groove in the eccentric body and also a centrally arranged pin on the internal gear which corresponds to the groove.

At the other end, there is an output shaft 2 which is mounted in a housing 4 and which is connected to an external gear 6. The external gear 6 and the internal gear 5 correspond and are positioned such that the external gear can roll within the internal gear.

In contrast to a conventional cycloidal speed reducer, the internal gear 5 does not rotate about its own axis but executes only an eccentric movement predetermined by the eccentric. As can be seen from FIG. 3, the internal gear 5 can thereby be supported and sealed against a housing 4 in a rotationally secure manner by, for example, a bellows 7.

Since the internal gear 6 and the external gear 5 have a different number of teeth, the external gear 5 is put into a rotational movement by the eccentric movement of the internal gear 6 itself. By means of the seal in the form of the bellows 7, for example, a vacuum space P1 and a space with atmospheric pressure P2 or vice versa can be separated hermetically from each other.

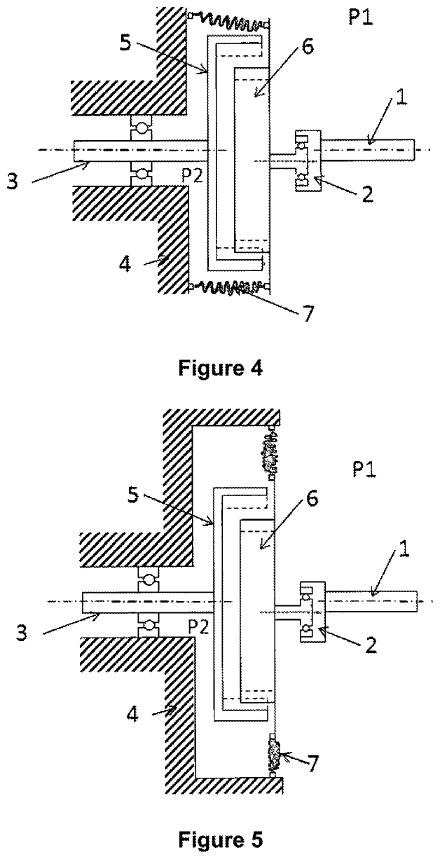

FIG. 4 shows a further embodiment of the invention in which the drive shaft 1 is now connected to an external gear 6 and the output shaft 3 is fixedly connected to an internal gear 5. Here too, a rotational movement D1 of the drive shaft 1 is converted first into an eccentric movement of the external gear 6, which causes a rotational movement D2 of the corresponding internal gear 5 which transmits this to the fixedly connected output shaft 3.

FIG. 5 shows a further embodiment of the invention similar to that in FIG. 5. In this case, however, the sealing is not effected by a bellows but, due to another geometric arrangement of the housing, by a flexible gas-impermeable film.

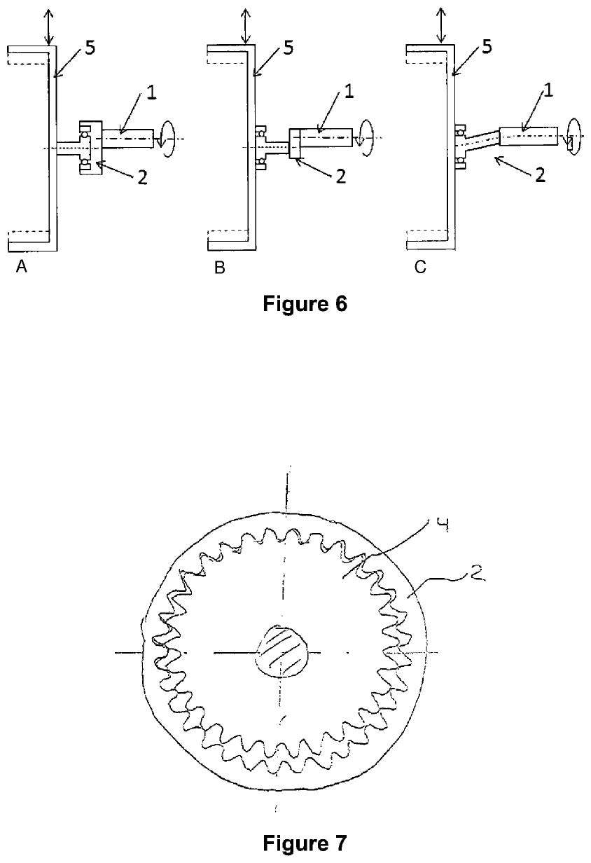

FIG. 6 shows, by way of example, possible and suitable embodiments of the coupling between the drive shaft 1 and an eccentric 2 fixedly connected thereto at one end and the gear flexibly connected thereto, wherein this can be either an internal gear or an external gear (not shown here) depending on the embodiment. In the embodiment on the left-hand side, an additional eccentric can be dispensed with, because here an angled drive shaft 1 simultaneously assumes the function of an eccentric.

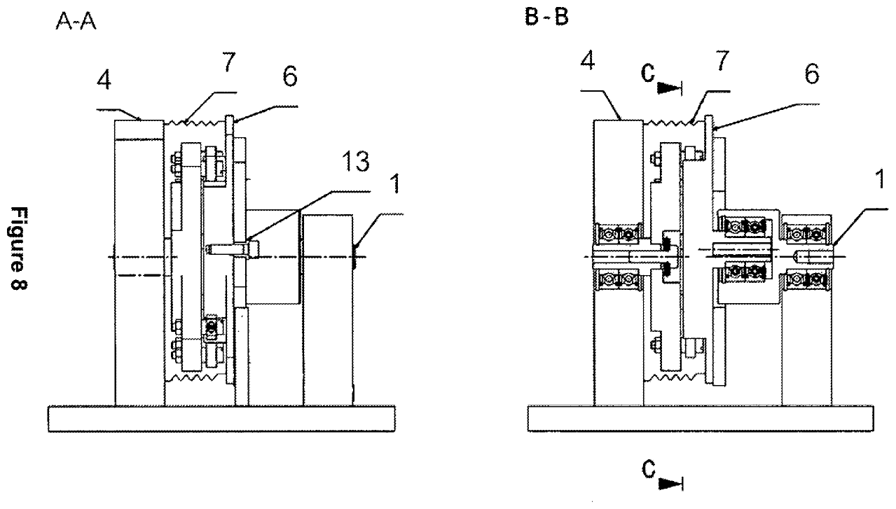

FIG. 7 shows the central arrangement of an external gear 6 and that of the circumferential internal gear 5 in cross section. Because the internal gear has i+x teeth but the external gear 6 has only i teeth, an eccentric movement of the internal gear forces the external gear into a rotational movement, since the teeth of the external gear roll correspondingly on the internal gear. Due to the different numbers of teeth, there is thus necessarily also a reduction in the rotational movements of the drive shaft and the output shaft. A 1:1 transmission of the rotational movement of the drive shaft to the output shaft cannot therefore be realized with the rotary feedthrough.

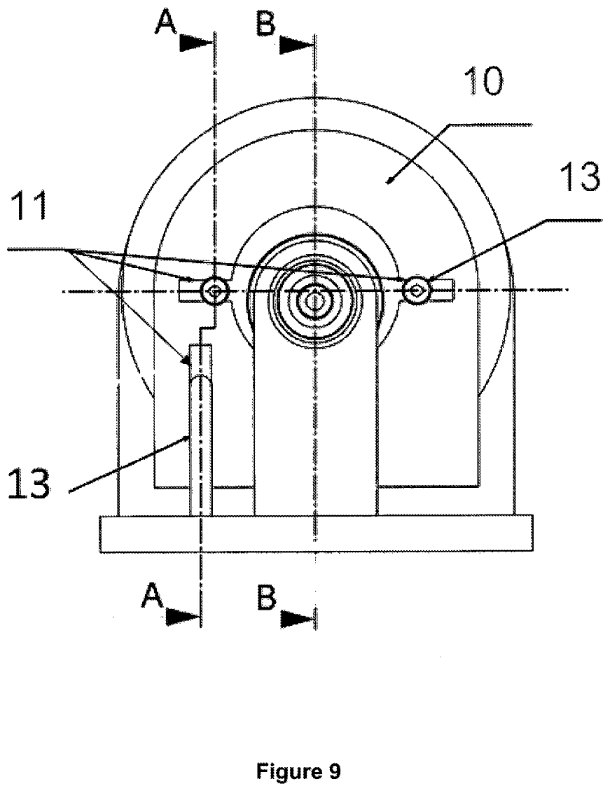

FIG. 8 shows a rotary feedthrough according to an embodiment of the invention with an additional support provided by an Oldham coupling (FIG. 9, section B-B). The drive shaft 1 generates a circular movement of the cycloidal disk 6. A bellows 7 is in turn fastened to the cycloidal disc 6 and makes possible the hermetic sealing to the housing 4. The torque support of the cycloidal disc (cam disk) 6 is provided by the Oldham coupling 10. In this embodiment this consists of a disk having two horizontal slots 11 and one vertical slot 12. Sleeves 13 fastened to the cam disk 6 engage in the horizontal slots 11. A carrier 14, which is fixedly connected to the housing 4, engages with the vertical slot. In principle, the Oldham coupling can also be dispensed with in the case of cycloidal speed reducers and the torque can be supported via the bellows.

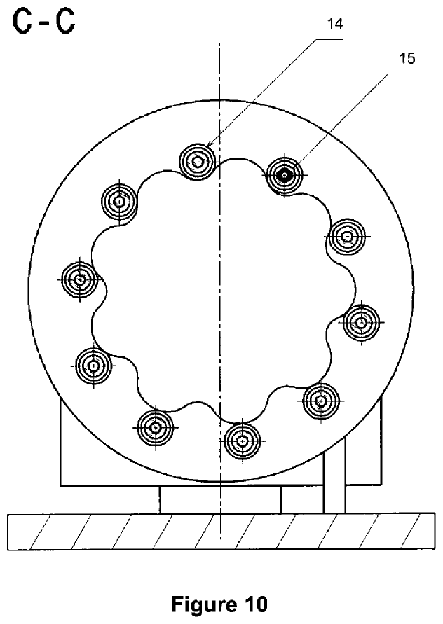

In FIG. 10 the engagement of the rolling elements 15 with the cycloidal disk (cam disk) can be seen. The rolling elements are in turn held here by roller bearings 16. The entire gear stage can thus be implemented in a purely rolling design.

Cycloidal speed reducers are not usually self-locking. A change from the drive end to the output end is thus also possible. In this way, for example, a faster rotational movement in the vacuum could also be generated.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

A. Drive shaft Al with eccentric E

B. Ball bearing for eccentric

C. Cam disk (external gear) with 10 (i) teeth and holes for pins

D. Fixed pin ring (internal gear) with 11 (i+1) teeth

E. Output shaft A2 connected by pins.

1 First shaft, in particular drive shaft

2 Means for coupling a gear to a first shaft

3 Second shaft, in particular output shaft

4 Housing

5 Internal gear/pin ring

6 External gear/cam/cycloidal disc

7 Means for sealing, in particular comprising at least one bellows or film

10 Oldham coupling

11 Horizontal slot of the Oldham coupling

12 Vertical slot of the Oldham coupling

13 Sleeves

14 Carrier

15 Rolling elements

16 Roller bearing

### CITED REFERENCES

[1] From: https://www.pfeiffer-vacuum.com/de/know-how/mechanische-komponenten-im-vakuum/manipulatoren-und-mechanische-durchführungen/funktionsprinzipien/balggedichtete-rotation/
[2]From: https://de.wikipedia.org/wiki/Zykloidgetriebe

1. A rotary feedthrough, comprising:
a first shaft connected to a first gear via a coupling;
a second shaft configured to be mounted in a housing and fixedly connected to a second gear, wherein one of the first gear and the second gear is an external gear with i teeth and the other of the first gear and the second gear is an internal gear with i+x teeth, where i=3, 4 . . . n and x=1, 2 . . . n, and wherein the external gear is arranged inside the internal gear and is able to roll therein,
a coupling configured to couple the first gear to the first shaft in such a way that a rotational movement of the first shaft leads to an eccentric movement of the first gear coupled thereto, and
a seal configured to connect the first gear coupled to the first shaft to the housing.

2. The rotary feedthrough according to claim 1, wherein an eccentric or an angled shaft is the coupling.

3. The rotary feedthrough according to claim 2, further comprising an eccentric comprising a groove and with a gear comprising a pin.

4. The rotary feedthrough according to claim 1, wherein the seal comprises at least one bellows.

5. The rotary feedthrough according to claim 1, wherein the second shaft is mounted in the housing and is connected to the internal gear, and wherein the first shaft is connected to the external gear via the coupling.

6. The rotary feedthrough according to claim 1, wherein the second shaft is mounted in the housing and is connected to the external gear, and wherein the first shaft is connected to the internal gear via the coupling.

7. The rotary feedthrough according to claim 1, wherein the external gear includes at least 6 teeth.

8. The rotary feedthrough according to claim 1, wherein the internal gear includes at least 7 teeth.

9. The rotary feedthrough according to claim 1, further comprising an additional clutch configured to compensate for an axial displacement between the drive shaft and output shaft.

10. The rotary feedthrough according to claim 1, wherein the internal gear and/or the external gear includes a metal, a high-performance plastic, or a ceramic.

11. The rotary feedthrough according to claim 9, wherein the additional clutch is configured to compensate for the axial displacement between the drive shaft and the output shaft with an Oldham coupling.
